(19) United States
(12) Patent Application Publication
(10) Pub. No.: US 2018/0248220 A1
(43) Pub. Date: Aug. 30, 2018

(54) NONAQUEOUS ELECTROLYTE SECONDARY BATTERIES

(71) Applicant: PANASONIC INTELLECTUAL PROPERTY MANAGEMENT CO., LTD., Osaka-shi, Osaka (JP)

(72) Inventors: Noriko Manabe, Osaka (JP); Kaoru Nagata, Osaka (JP); Masahiro Kinoshita, Osaka (JP); Taizou Sunano, Tokushima (JP)

(73) Assignee: PANASONIC INTELLECTUAL PROPERTY MANAGEMENT CO., LTD., Osaka-shi, Osaka (JP)

(21) Appl. No.: 15/753,772

(22) PCT Filed: Aug. 23, 2016
(86) PCT No.: PCT/JP2016/003814

§ 371 Date: Feb. 20, 2018

(30) Foreign Application Priority Data
Aug. 28, 2015 (JP) 2015-169790

(51) Int. Cl. H01M 10/0525; H01M 4/525; H01M 4/587; H01M 4/38; H01M 4/36

(52) U.S. Cl. CPC H01M 10/0525; H01M 4/525; H01M 4/364; H01M 4/386; H01M 4/587

(57) ABSTRACT

In a nonaqueous electrolyte secondary battery which includes an electrode assembly that includes a positive electrode including a positive electrode current collector and a positive electrode mixture layer, a negative electrode including a negative electrode current collector and a negative electrode mixture layer, and a separator, the positive electrode mixture layer contains Ni in a proportion of not less than 85 mol % relative to the total molar amount of metal element(s) except lithium, and includes a lithium transition metal oxide bearing on the surface thereof an attached element belonging to Group VI of the periodic table. The negative electrode mixture layer includes a carbon material and a silicon compound. The surface pressure present on a plane in which the positive electrode and the negative electrode are opposed to each other through the separator is not less than 0.1 MPa/cm².

### TECHNICAL FIELD

The present invention relates to nonaqueous electrolyte secondary batteries.

### BACKGROUND ART

With the recent accelerated reduction in the size and weight of mobile information terminals such as cellphones, laptop computers and smartphones, there is a demand for higher capacities of batteries that drive such devices. Nonaqueous electrolyte secondary batteries which are charged and discharged by the movement of lithium ions between positive and negative electrodes, have a high energy density and a high capacity and are widely used as power supplies for driving the mobile information terminals.

Further, nonaqueous electrolyte secondary batteries recently attract attention as power supplies for powering electric vehicles, electric tools and the like, and are expected to find a wider range of applications. Batteries used as such power supplies are required to have a high capacity for long use and also to have a high output. There is a growing demand that batteries, in particular, batteries for vehicles, not only have a high capacity and a high output but also attain enhancements in high-temperature cycle characteristics.

Patent Literature 1 describes that the reaction resistance of a positive electrode is reduced by forming lithium tungsten oxide or a hydrate thereof on the surface of primary particles of a lithium transition metal composite oxide powder as a positive electrode active material for nonaqueous electrolyte secondary batteries, and consequently the capacity and output of batteries can be increased.

Patent Literature 2 describes that the addition of Mo, W or Mn in a predetermined proportion to a Ni-excess lithium transition metal composite oxide realizes an increase in capacity and also reduces the maximum amount of heat generated when a charged battery is exposed to a high temperature, leading to an improvement in thermal stability in the charged state.

### CITATION LIST

### Patent Literature

PTL 1: Japanese Published Unexamined Patent Application No. 2013-152866

PTL 2: Japanese Published Unexamined Patent Application No. 2012-178312

### SUMMARY OF INVENTION

### Technical Problem

Unfortunately, the techniques disclosed in Patent Literature 1 and Patent Literature 2 are incapable of attaining an enhancement in cycle characteristics at high temperatures. A positive electrode active material prepared by adding tungsten to a Ni-excess lithium transition metal composite oxide is very effective in increasing capacity and output at the same time. However, the present inventors have found that a lithium transition metal composite oxide increases its electronic resistance and lowers electron conductivity with increasing proportion of Ni, and that the electronic resistance is further raised by the addition of tungsten as compared to when tungsten is absent. In high-temperature charge discharge cycles where more Li ions are intercalated and deintercalated and the electrodes are prone to expansion and shrinkage to a greater extent, the electrical contact (conductive paths) between active material particles or between an active material and a conductive auxiliary tends to be weak. Consequently, if tungsten is added to a Ni-excess lithium transition metal composite oxide having a high electronic resistance, the resultant positive electrode active material shows a marked increase in electrode plate resistance during charge discharge cycles, causing a decrease in capacity retention ratio.

In addition, when lithium metal, carbon material and others are used as a negative electrode, the intercalation and deintercalation of Li tend to be promoted at a high temperature as compared to at room temperature and are thus accompanied by larger expansion and shrinkage of a positive electrode. In this case, it is particularly difficult to ensure conductive paths in the electrode plate. Further, an electronic resistance layer tends to be formed on the surface of the electrode plate by the decomposition of the electrolytic solution. As a result, the battery decreases the capacity to a greater extent during charge discharge cycles.

The present disclosure provides a nonaqueous electrolyte secondary battery that exhibits excellent high-temperature cycle characteristics as well as having a high capacity and a high output.

### Solution to Problem

In a nonaqueous electrolyte secondary battery which includes an electrode assembly that includes a positive electrode including a positive electrode current collector and a positive electrode mixture layer disposed on the positive electrode current collector, a negative electrode including a negative electrode current collector and a negative electrode mixture layer disposed on the negative electrode current collector, and a separator, the positive electrode mixture layer contains Ni in a proportion of not less than 85 mol % relative to the total molar amount of metal element(s) except lithium, and includes a lithium transition metal oxide bearing on the surface thereof an attached element belonging to Group VI of the periodic table. The negative electrode mixture layer includes a carbon material and a silicon compound. The surface pressure present on a plane in which the positive electrode and the negative electrode are opposed to each other through the separator is not less than 0.1 MPa/cm².

### Advantageous Effects of Invention

A nonaqueous electrolyte secondary battery according to one aspect of the present disclosure has a high capacity and a high output and also exhibits excellent high-temperature cycle characteristics.

### BRIEF DESCRIPTION OF DRAWINGS

FIG. 1 is a schematic sectional view illustrating a general structure of a nonaqueous electrolyte secondary battery according to one embodiment of the present disclosure.

FIG. 2 is a set of schematic views of a positive electrode used in the nonaqueous electrolyte secondary battery of FIG. 1. FIG. 2(a) is a plan view of the positive electrode, FIG. 2(b) a sectional view of the positive electrode, and FIG. 2(c) a rear view of the positive electrode.

FIG. 3 is a set of schematic views of a negative electrode used in the nonaqueous electrolyte secondary battery of FIG. 1. FIG. 3(a) is a plan view of the negative electrode, FIG. 3(b) a sectional view of the negative electrode, and FIG. 3(c) a rear view of the negative electrode.

### DESCRIPTION OF EMBODIMENTS

Some examples of the embodiments of the present disclosure will be described in detail. The embodiments of the present disclosure may be changed appropriately without departing from the spirit of the present disclosure. The drawings that are referred to in the explanation of the embodiments are schematic, and the configurations such as the sizes of the constituent elements illustrated in the drawings may differ from the actual ones.

### <Nonaqueous Electrolyte Secondary Batteries>

A nonaqueous electrolyte secondary battery representing an example embodiment includes a positive electrode that has a positive electrode mixture layer including a lithium transition metal oxide containing at least Ni, and a conductive auxiliary; a negative electrode including a carbon material and a silicon compound; a separator; a nonaqueous electrolyte; and a battery case accommodating these constituent elements. The lithium transition metal oxide contains Ni in a proportion of not less than 85 mol % relative to the total molar amount of metal element(s) except lithium, and bears a Group VI element attached on the surface of at least either of primary particles or secondary particles. The Group VI element is preferably attached as a Group VI element compound, and is more preferably attached as a tungsten compound. The silicon compound is preferably SiOₓ (0.5≤x≤1.5). The content of the silicon compound in the negative electrode is preferably not less than 5 mass % and less than 30 mass % of the total mass of the carbon material and the silicon compound.

Studies by the present inventors have concluded that a lithium transition metal oxide containing 85 mol % or more Ni allows for higher capacity as compared to lithium transition metal oxides containing no or less than 85 mol % Ni such as LiCoO₂, LiFePO₄, LiMn₂O₄, LiNi_{0.4}Co_{0.6}O₂ and LiNi_{0.4}Mn_{0.6}O₂. On the other hand, a lithium transition metal oxide containing 85 mol % or more Ni decreases its electron conductivity with increasing proportion of Ni and is swollen and shrunk to a larger extent during charging and discharging, with the result that high-temperature cycle characteristics are deteriorated.

The electronic resistance is further raised when a tungsten compound is added to a lithium transition metal oxide having a high Ni content. That is, a positive electrode material prepared by adding a tungsten compound to a lithium transition metal oxide containing Ni in a high proportion attains a reduction in the reaction resistance of the positive electrode, but, as compared with a positive electrode mixture having the same composition, shows a higher electrode plate resistance and causes the capacity retention ratio to be decreased. In particular, the increase in electrode plate resistance is more marked and the decrease in capacity retention ratio is more significant when charge discharge cycles occur at high temperatures where the electrode assembly is more prone to expanding.

In a nonaqueous electrolyte secondary battery according to an example embodiment, a tungsten compound is attached to the lithium transition metal oxide containing Ni in a proportion of not less than 85 mol %, and the negative electrode mixture layer includes SiOₓ (0.5≤x≤1.5). This battery also includes an electrode assembly in which the positive and negative electrode plates are wound with a tension so predetermined that a surface pressure of not less than 0.1 MPa/cm² will be present on the facing surfaces of the positive electrode and the negative electrode which are opposed to each other through the separator. During charging of the battery, SiOₓ is expanded under a surface pressure of not less than 0.1 MPa/cm². The expansion pressure of SiOₓ suppresses the swelling of the positive electrode plate, and allows the positive electrode active material and the conductive auxiliary to attain an improved electrical contact. Consequently, the nonaqueous electrolyte secondary battery achieves excellent high-temperature cycle characteristics while ensuring a high capacity and a high output.

In the configuration described above, the electrical contact between the positive electrode active material and the conductive auxiliary can be further improved by controlling the SiOₓ content to not less than 5 mass % and less than 30 mass % of the total mass of the SiOₓ and the carbon material present in the negative electrode mixture layer. In this manner, an enhancement may be obtained in cycle characteristics at high temperatures where the electrodes are more prone to expanding.

When lithium difluorophosphate (LiPO₂F₂) is contained in the nonaqueous electrolyte, it forms a film on the surface of the positive electrode active material to prevent the dissolution of the tungsten compound during charging and discharging. As a result, the battery attains a higher capacity.

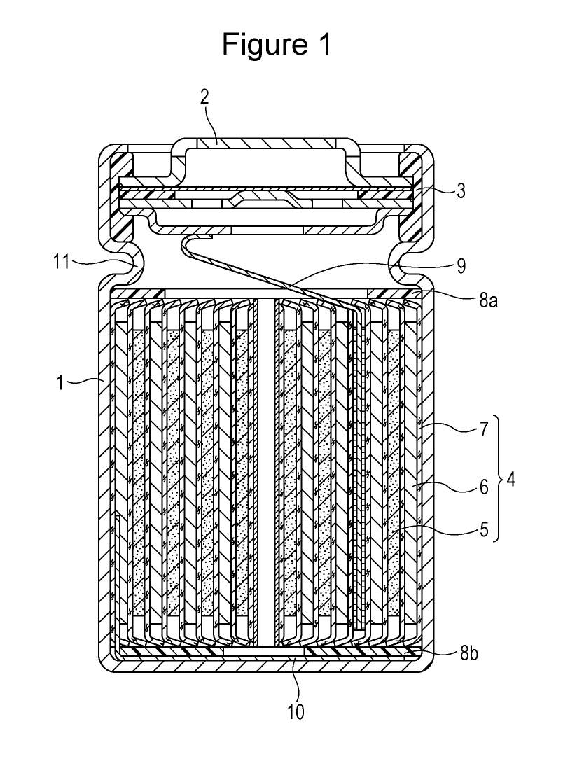

FIG. 1 is a sectional view schematically illustrating a general structure of a nonaqueous electrolyte secondary battery according to an embodiment of the present disclosure. The nonaqueous electrolyte secondary battery has an electrode assembly 4 in which a long positive electrode 5 and a long negative electrode 6 are wound together while a separator 7 is interposed between the positive electrode 5 and the negative electrode 6. A bottomed cylindrical battery case 1 made of a metal accommodates the electrode assembly 4 and a nonaqueous electrolyte that is not shown.

In the electrode assembly 4, a positive electrode lead 9 is electrically connected to the positive electrode 5, and a negative electrode lead 10 is electrically connected to the negative electrode 6. The electrode assembly 4 is accommodated in the battery case 1 together with a lower insulating ring 8b while the positive electrode lead 9 leads out from the assembly. A sealing plate 2 is welded to the end of the positive electrode lead 9, and thereby the positive electrode 5 and the sealing plate 2 are electrically connected to each other. The lower insulating ring 8b is disposed between the bottom surface of the electrode assembly 4 and the negative electrode lead 10 leading out from the electrode assembly 4 in the downward direction. The negative electrode lead 10 is welded to the inner bottom surface of the battery case 1, and thereby the negative electrode 6 and the battery case 1 are electrically connected to each other. An upper insulating ring 8a is disposed on the top surface of the electrode assembly 4.

The electrode assembly 4 is held in the battery case 1 by a step 11 that protrudes inwardly at an upper portion of the sidewall of the battery case 1 above the upper insulating ring 8a. The sealing plate 2 that is fitted with a gasket 3 made of a resin along its periphery is disposed on the step 11, and the open end of the battery case 1 is crimped inwardly to form a seal.

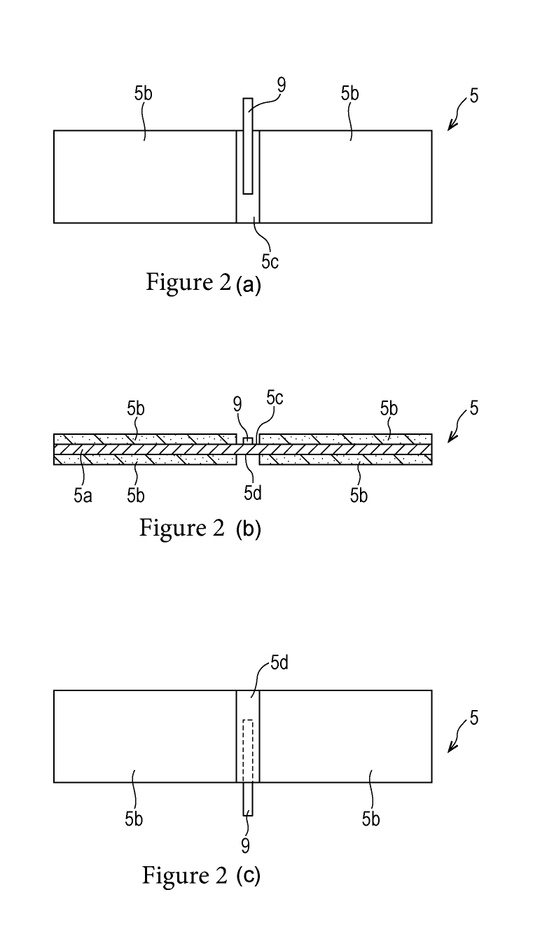

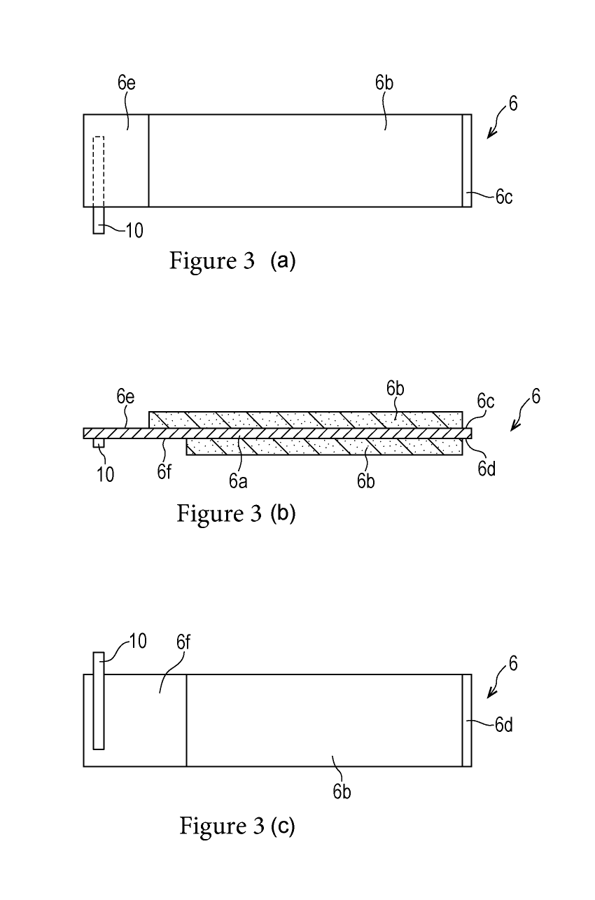

FIG. 2(a), FIG. 2(b) and FIG. 2(c) are a plan view, a sectional view and a rear view, respectively, schematically illustrating the positive electrode 5 used in the nonaqueous electrolyte secondary battery of FIG. 1. FIG. 3(a), FIG. 3(b) and FIG. 3(c) are a plan view, a sectional view and a rear view, respectively, schematically illustrating the negative electrode 6 used in the nonaqueous electrolyte secondary battery of FIG. 1.

The positive electrode 5 includes a long positive electrode current collector 5a, and positive electrode mixture layers 5b disposed on both sides of the positive electrode current collector 5a. On both sides of the positive electrode current collector 5a, portions 5c and 5d of the positive electrode current collector are exposed from the positive electrode mixture layer 5b at central regions of the surface in the longitudinal direction so as to extend across the width direction. The end of the positive electrode lead 9 is welded to the exposed portion 5c of the positive electrode current collector.

The negative electrode 6 includes a long negative electrode current collector 6a, and negative electrode mixture layers 6b disposed on both sides of the negative electrode current collector 6a. At one end of the negative electrode 6 in the longitudinal direction, equally sized portions 6c and 6d of the negative electrode current collector are exposed from the negative electrode mixture layer 6b on both sides of the negative electrode 6. At the other end of the negative electrode 6 in the longitudinal direction, portions 6e and 6f of the negative electrode current collector are exposed from the negative electrode mixture layer 6b on both sides of the negative electrode 6. The widths of the exposed portions 6e and 6f of the negative electrode current collector (the lengths in the longitudinal direction of the negative electrode 6) are such that the exposed portion 6f of the negative electrode current collector extends farther than the exposed portion 6e of the negative electrode current collector. The end of the negative electrode lead 10 is welded to the exposed portion 6f of the negative electrode current collector in the vicinity of the end of the negative electrode 6 in the longitudinal direction. This arrangement of the leads allows for efficient penetration of the nonaqueous electrolyte through the central regions of the positive electrode 5 in the longitudinal direction and through the ends of the negative electrode 6 in the longitudinal direction.

The structure of the electrode assembly 4, and the battery case 1 of the nonaqueous electrolyte secondary battery are not limited to those described above. For example, the structure of the electrode assembly 4 may be a stack type in which positive electrodes 5 and negative electrodes 6 are stacked alternately via separators 7. The battery case 1 may be a metallic prismatic battery case or an aluminum laminate film. In particular, a cylindrical battery case is preferable from the point of view of the heat dissipation of the battery. Some example metal materials which may be used to form the battery cases are aluminum, aluminum alloys (for example, alloys containing trace amounts of such metals as manganese and copper) and steel plates. Where necessary, the battery case 1 may be plated with nickel or the like. The positive electrode mixture layer may be disposed on only one side of the positive electrode current collector 5a. Similarly, the negative electrode mixture layer may be disposed on only one side of the negative electrode current collector 6a. Hereinbelow, the constituent elements will be described in more detail.

### [Positive Electrodes]

The positive electrode current collector 5a may be a nonporous conductive substrate or may be a porous conductive substrate having a plurality of through-holes. Examples of the nonporous conductive substrates include metal foils and metal sheets. Examples of the porous conductive substrates include metal foils having connected holes (pores), meshes, nets, punched sheets, expanded metals and lath materials. Examples of the metal materials used as the positive electrode current collectors 5a include stainless steel, titanium, aluminum and aluminum alloys. For example, the thickness of the positive electrode current collector 5a may be selected from the range of 3 to 50 μm, and is preferably 5 to 30 μm, and more preferably 10 to 20 μm.

The positive electrode mixture layers include a positive electrode active material and a conductive auxiliary, and may further contain additives such as, for example, a binder and a thickener as required.

The positive electrode active material that is used is a lithium transition metal oxide. The lithium transition metal oxide contains lithium and a metal element(s) other than lithium. The metal element(s) includes at least Ni, and the proportion of Ni is not less than 85 mol % relative to the total molar amount of the metal element(s) except lithium in the lithium transition metal oxide. Lithium transition metal oxides containing less than 85 mol % Ni have a low electronic resistance and are therefore free from a problem of poor high-temperature cycle characteristics. The positive electrode active material is usually used in the form of particles. A known positive electrode active material capable of storing and releasing lithium ions may be additionally used. The positive electrode active materials may be used singly, or a plurality of materials may be used as a mixture.

Examples of the metal elements other than Ni include transition metal elements such as Co and Mn, and non-transition metal elements such as Mg and Al. It is preferable that the metal elements include at least one of Co and Al. Specific examples include lithium transition metal oxides of Ni—Co—Mn, Ni—Mn—Al, and Ni—Co—Al.

The lithium transition metal oxide is preferably an oxide represented by the general formula: LiₐNiₓM₁₋ₓO₂ (wherein 0.95≤a≤1.2, 0.85≤x≤1.0, and M includes at least Co and Al). In the general formula, x is more preferably 0.85≤x<1.0. To increase capacity and output and to enhance high-temperature cycle characteristics, x in the above general formula is particularly preferably 0.90<x≤0.95.

Specific examples of preferred lithium transition metal oxides include LiNi_{0.88}Co_{0.09}Al_{0.03}O₂, LiNi_{0.91}Co_{0.06}Al_{0.03}O₂ and LiNi_{0.94}Co_{0.03}Al_{0.03}O₂. The lithium transition metal oxide may be partially substituted with other element such as fluorine in place of oxygen.

The particles of the lithium transition metal oxide bear an attached element belonging to Group VI of the periodic table, on the surface of at least either of primary particles and secondary particles. The Group VI element is preferably attached as a Group VI element compound. The group VI element or the Group VI element compound is preferably attached to the surface of both of the primary particles and the secondary particles. The amount in which the Group VI element is attached is not limited as long as the Group VI element is present, but is preferably not less than 0.10 mol % in terms of Group VI element relative to the total molar amount of metal elements except lithium in the lithium transition metal oxide.

From the point of view of specific capacity, heavy attachment of the Group VI element, which does not contribute to capacity, may cause a decrease in capacity. Thus, the amount of the Group VI element attached is particularly preferably not less than 0.10 mol and not more than 1.0 mol in terms of Group VI element relative to the total molar amount of metal elements except lithium in the lithium transition metal oxide.

The Group VI element that is attached to the surface of the lithium transition metal oxide is preferably tungsten. The Group VI element compound is preferably at least one kind of a tungsten compound selected from tungsten oxides and tungsten lithium composite oxides. Some more preferred compounds are WO₃, Li₂WO₄ and WO₂.

The Group VI element or the Group VI element compound may be attached to the surface of the lithium transition metal composite oxide by, for example, a method in which the lithium transition metal oxide and the Group VI element or the Group VI element compound are mixed during the preparation of the positive electrode mixture slurry, or a method in which the lithium transition metal oxide after being calcined is mixed with the Group VI element or the Group VI element compound and the mixture is heat treated.

To ensure that the Group VI element or the Group VI element compound will be attached to the surface of both of the primary particles and the secondary particles of the lithium transition metal oxide, it is more preferable to adopt a method in which the lithium transition metal oxide after being calcined is mixed with the Group VI element or the Group VI element compound and the mixture is heat treated.

The positive electrode 5 may be obtained by, for example, applying a positive electrode mixture slurry which includes positive electrode mixture layer components such as the positive electrode active material, a conductive auxiliary and a binder in a dispersion medium, to a surface of the positive electrode current collector 5a, and rolling the resultant coating with a pair of rolls or the like followed by drying to form a positive electrode mixture layer on the surface of the positive electrode current collector 5a. Where necessary, the coating may be dried before the rolling.

The conductive auxiliary may be a known material, with examples including carbon blacks such as acetylene black; conductive fibers such as carbon fibers and metal fibers; and carbon fluorides. The conductive auxiliaries may be used singly, or two or more may be used in combination.

The content of the conductive auxiliary in the positive electrode mixture layer is preferably not less than 0.5 mass % and not more than 1.5 mass % relative to the positive electrode active material taken as 100 mass %. If the content of the conductive auxiliary is less than 0.5 mass %, the amount of the conductive auxiliary present in the positive electrode 5 is so small that a good electrical contact is not obtained between the positive electrode active material and the conductive auxiliary within the positive electrode 5 and consequently the discharge characteristics of the battery are significantly decreased at times. If, on the other hand, the content of the conductive auxiliary exceeds 1.5 mass %, the amount of the conductive auxiliary present in the positive electrode 5 is so large that the battery capacity is decreased.

The binder may be a known binding agent, with examples including fluororesins such as polytetrafluoroethylene (PTFE), polyvinylidene fluoride (PVDF) and vinylidene fluoride (VDF)-hexafluoropropylene (HFP) copolymer; polyolefin resins such as polyethylene and polypropylene; polyamide resins such as aramid; and rubbery materials such as styrene-butadiene rubber and acrylic rubber. The binders may be used singly, or two or more may be used in combination.

The content of the binder in the positive electrode mixture layer is appropriately, for example, not more than 10 mass % relative to the positive electrode active material taken as 100 mass %. To increase the battery capacity by increasing the density of the mixture, the amount of the binder is preferably not more than 5 mass %, and more preferably not more than 3 mass %. The lower limit of the content of the binder is not particularly limited, and the amount may be, for example, 0.01 mass % or less relative to the positive electrode active material taken as 100 mass %.

Examples of the thickeners include cellulose derivatives such as carboxymethylcellulose (CMC); C2-4 polyalkylene glycols such as polyethylene glycol and ethylene oxide-propylene oxide copolymer; polyvinyl alcohols; and solubilized modified rubbers. The thickeners may be used singly, or two or more may be used in combination.

The proportion of the thickener is not particularly limited, but is preferably, for example, not less than 0 mass % and not more than 10 mass %, and more preferably not less than 0.01 mass % and not more than 5 mass % relative to the positive electrode active material taken as 100 mass %.

The dispersion medium is not particularly limited. Examples thereof include water, alcohols such as ethanol, ethers such as tetrahydrofuran, amides such as dimethylformamide, N-methyl-2-pyrrolidone (NMP), and mixtures of these solvents.

The thickness of the positive electrode mixture layers is preferably, for example, 20 to 100 μm, more preferably 30 to 90 μm, and particularly preferably 50 to 80 μm per side of the positive electrode current collector 5a. The density of the active material in the positive electrode mixture layers is preferably, for example, 3.3 to 4.0 g/cm³, more preferably 3.4 to 3.9 g/cm³, and particularly preferably 3.5 to 3.7 g/cm³ in terms of the average of the entirety of the positive electrode mixture layers.

### [Negative Electrodes]

Similarly to the positive electrode current collector 5a, the negative electrode current collector 6a may be a nonporous or porous conductive substrate. The thickness of the negative electrode current collector 6a may be selected from the same range as the thickness of the positive electrode current collector 5a. Examples of the metal materials used as the negative electrode current collectors 6a include stainless steel, nickel, copper and copper alloys. In particular, among others, copper and copper alloys are preferable.

The negative electrode mixture layers, which are described later, include, for example, a negative electrode active material and a binder. In addition to these components, additives such as a conductive auxiliary and a thickener may be added as required. The negative electrode 6 may be formed in accordance with the method by which the positive electrode 5 is formed. Specifically, the negative electrode may be obtained by applying a negative electrode mixture slurry which includes negative electrode mixture layer components such as the negative electrode active material and the binder in a dispersion medium, to a surface of the negative electrode current collector 6a, and rolling and drying the resultant coating to form a negative electrode mixture layer on the surface of the negative electrode current collector 6a.

The negative electrode active material includes a carbon material and a silicon compound. Examples of the carbon materials include various carbonaceous materials such as, for example, graphites (such as natural graphite, artificial graphite and graphitized mesophase carbon), cokes, semi-graphitized carbons, graphitized carbon fibers and amorphous carbons. Examples of the silicon compounds include silicon and silicon-containing compounds such as silicon oxides SiOₓ (0.05<x<1.95) and silicides. The silicon compound is preferably SiOₓ (0.5≤x≤1.5).

To attain enhancements in cycle characteristics and battery safety, the proportion of SiOₓ is more preferably not less than 2 mass % and not more than 50 mass %, and particularly preferably not less than 5 mass % and less than 30 mass % of the total mass of the carbon material and SiOₓ taken as 100 mass %.

If the proportion of SiOₓ is less than 2 mass %, the negative electrode mixture layer comes to exert a low expansion pressure in the battery case 1 and reduces its effect in improving the electrical contact between the positive electrode active material and the conductive auxiliary, with the result that the enhancement in high-temperature cycle characteristics becomes insufficient. If, on the other hand, the proportion of SiOₓ exceeds 50 mass %, the expansion and shrinkage of SiOₓ during charging and discharging comes to have a profound influence on the negative electrode mixture layer (for example, a separation occurs between the negative electrode current collector 6a and the negative electrode mixture layer), and consequently cycle characteristics are deteriorated.

The surface of SiOₓ may be coated with carbon. Because the SiOₓ is poorly conductive to electrons, an increase in electron conductivity may be obtained by coating the surface with carbon.

The negative electrode active material may include chalcogen compounds capable of storing and releasing lithium ions at a lower potential than the positive electrode 5 such as transition metal oxides and transition metal sulfides; and lithium alloys and various alloy composition materials containing at least one selected from the group consisting of tin, aluminum, zinc and magnesium. To ensure that the positive electrode active material occupies a high proportion of the inside of the battery case 1, it is preferable to use a material having a high specific capacity in the negative electrode active material.

Examples of the binders, the dispersion media, the conductive auxiliaries and the thickeners used in the negative electrode 6 may be similar to those mentioned with respect to the positive electrode 5. The amounts of the components relative to the negative electrode active material may be selected from the same ranges as mentioned with respect to the positive electrode 5.

For example, the thickness of the negative electrode mixture layers is preferably 40 to 120 μm, more preferably 50 to 110 m, and particularly preferably 70 to 100 m per side of the negative electrode current collector 6a. The density of the active material in the negative electrode mixture layers is preferably 1.3 to 1.9 g/cm³, more preferably 1.4 to 1.8 g/cm³, and particularly preferably 1.5 to 1.7 g/cm³ in terms of the average of the entirety of the negative electrode mixture layers. In the case where the negative electrode active material includes additional components such as, for example, silicon, tin, aluminum, zinc and magnesium, the thickness and active material density of the negative electrode mixture layers may be outside the above ranges and may be controlled appropriately.

In the electrode assembly 4 in which the positive electrode 5 and the negative electrode 6 described above are wound together, a surface pressure of not less than 0.1 MPa/cm² is present on a plane in which the positive electrode 5 and the negative electrode 6 are opposed to each other through the separator 7. In particular, it is preferable that the surface pressure present on a plane in which the positive electrode 5 and the negative electrode 6 are opposed to each other through the separator be not less than 0.1 MPa/cm² at 100% SOC (state of charge). The surface pressure is suitably 0.1 MPa/cm² or more at other than 100% SOC, such as at 0% SOC or 50% SOC. It is preferable that each of the facing surfaces of the positive electrode 5 and the negative electrode 6 which are opposed to each other through the separator be under a surface pressure of not less than 0.1 MPa/cm² at the outermost periphery of the electrode assembly 4. Further, it is preferable that the surface pressure present on a plane in which the positive electrode 5 and the negative electrode 6 are opposed to each other through the separator be not less than 0.1 MPa/cm² throughout the entirety of the electrode assembly 4 from the innermost core to the outermost periphery. In the case where the electrode assembly 4 is a stack, it is preferable that each of the planes in which the positive electrode 5 and the negative electrode 6 are opposed to each other through the separator be under a surface pressure of not less than 0.1 MPa/cm². The 100% SOC is defined as the state that is reached when the battery is charged to a battery voltage of 4.2 V.

To ensure that a surface pressure of not less than 0.1 MPa/cm² will be present on a plane in which the positive electrode 5 and the negative electrode 6 are opposed to each other through the separator 7 irrespective of the SOC of the battery, the shape of the electrode assembly 4 and the position within the electrode plates, it is preferable that the electrode assembly 4 be fabricated while appropriately applying a predetermined tension to the positive electrode 5 and the negative electrode 6 being assembled via the separator 7.

The surface pressure may be determined by interposing carbonless copy paper between the positive electrode 5 and the negative electrode 6 via the separator 7. When, for example, the material of the separator 7 is known, the surface pressure may be calculated from a result obtained by measuring the change in porosity of the separator. The effect of suppressing the aforementioned decrease in capacity retention ratio during cycles is markedly taken advantage of particularly in a high-energy density battery having a capacity of not less than 4 mAh/cm² per unit area in which the positive electrode and the negative electrode are opposed to each other.

### [Separators]

Examples of the separators 7 disposed between the positive electrode 5 and the negative electrode 6 include microporous films, nonwoven fabrics and woven fabrics made of resins. In particular, the base materials for forming the separators 7 may be, for example, polyolefins such as polyethylene and polypropylene in order to attain an enhancement in safety by the shutdown function. It is preferable that the surface of the separator 7 be provided with a heat resistant layer including a heat resistant material. Examples of the heat resistant materials include polyamide resins such as aliphatic polyamides and aromatic polyamides (aramids); and polyimide resins such as polyamidimides and polyimides. The heat resistant layer may be formed on the surface of the positive electrode 5 or the negative electrode 6 as long as it is disposed between the positive electrode 5 or the negative electrode 6, and the separator 7. To prevent the separator from being degraded by the heat generated by the positive electrode 5 during discharging under high temperature conditions, it is particularly preferable that the heat resistant layer be disposed between the positive electrode 5 and the separator 7.

### [Nonaqueous Electrolytes]

The solvent in the nonaqueous electrolyte is not particularly limited and may be any of the solvents conventionally used in nonaqueous electrolyte secondary batteries. Examples include cyclic carbonates such as ethylene carbonate, propylene carbonate, butylene carbonate and vinylene carbonate, chain carbonates such as dimethyl carbonate, ethyl methyl carbonate and diethyl carbonate, ester-containing compounds such as methyl acetate, ethyl acetate, propyl acetate, methyl propionate, ethyl propionate, γ-butyrolactone and γ-valerolactone, sulfone group-containing compounds such as propanesultone, ether-containing compounds such as 1,2-dimethoxyethane, 1,2-diethoxyethane, tetrahydrofuran, 1,2-dioxane, 1,4-dioxane and 2-methyltetrahydrofuran, nitrile-containing compounds such as butyronitrile, valeronitrile, n-heptanenitrile, succinonitrile, glutaronitrile, adiponitrile, pimelonitrile, 1,2,3-propanetricarbonitrile and 1,3,5-pentanetricarbonitrile, and amide-containing compounds such as dimethylformamide. In particular, these solvents which are partially substituted with fluorine in place of hydrogen may be preferably used. These solvents may be used singly, or a plurality of solvents may be used in combination. In particular, a preferred solvent is a combination of a cyclic carbonate and a chain carbonate, or a combination of the above combination with a small amount of a nitrile-containing compound or an ether-containing compound.

The nonaqueous solvent in the nonaqueous electrolyte may be an ionic liquid. In this case, the cation species and the anion species are not particularly limited. From the points of view of low viscosity, electrochemical stability and hydrophobicity, a particularly preferred combination involves a pyridinium cation, an imidazolium cation or a quaternary ammonium cation as the cation and a fluorine-containing imide anion as the anion.

The solute used in the nonaqueous electrolyte may be a known lithium salt generally used in conventional nonaqueous electrolyte secondary batteries. Examples of such lithium salts include those lithium salts containing one or more elements of P, B, F, O, S, N and Cl. Specific examples include LiPF₆, LiBF₄, LiCF₃SO₃, LiN(FSO₂)₂, LiN(CF₃SO₂)₂, LiN(C₂F₅SO₂)₂, LiN(CF₃SO₂) (C₄F₉SO₂), LiC(C₂F₅SO₂)₃, LiAsF₆, LiClO₄ and mixtures of these lithium salts. Of the lithium salts, lithium salts of fluorine-containing acids, in particular LiPF₆, are preferable because they are easily dissociated and are chemically stable in the nonaqueous electrolyte.

To make high-level use of the positive electrode active material in the battery, the concentration of the solute is particularly preferably not less than 1.4 mol per 1 liter of the nonaqueous electrolytic solution.

The nonaqueous electrolyte may contain known additives as required, for example, cyclohexylbenzene and diphenyl ether. In particular, the nonaqueous electrolyte preferably contains lithium difluorophosphate (LiPO₂F₂). When contained in the nonaqueous electrolyte, lithium difluorophosphate is decomposed on the tungsten compound to form a film on the surface of the positive electrode active material. This film can prevent the tungsten compound from being dissolved during charging and discharging or during storage at a high temperature, and is therefore effective for enhancing the discharge capacity. Lithium difluorophosphate is preferably present in a concentration of 0.1 mass % to 2 mass % relative to the nonaqueous solvent.

### (Other Constituent Elements)

Examples of the materials of the positive electrode leads 9 and the negative electrode leads 10 include the respective metal materials mentioned for the positive electrode current collectors 5a and the negative electrode current collectors 6a. Specifically, such materials as aluminum plates may be used as the positive electrode leads 9, and such materials as nickel plates and copper plates may be used as the negative electrode leads 10. Further, clad leads may be used as the negative electrode leads 10.

Hereinbelow, the nonaqueous electrolyte secondary batteries according to one aspect of the present disclosure will be described in detail based on various EXAMPLES. The EXAMPLES given below only illustrate some examples of the nonaqueous electrolyte secondary batteries to give a concrete form to the technical idea of the present disclosure, and thus do not intend to limit the embodiments of the present disclosure to any of such EXAMPLES. The embodiments may be carried out while adding appropriate modifications to those EXAMPLES without departing from the spirit of the present disclosure.

### First Experimental Examples

### Example 1

### [Preparation of Positive Electrode Active Material]

Tungsten oxide (WO₃) was mixed with particles of layered lithium nickel cobalt aluminum oxide represented by LiNi_{0.91}Co_{0.06}Al_{0.03}O₂ as a lithium transition metal oxide. The mixture was heat treated at 200° C. to give a positive electrode active material in which the tungsten compound was attached to the surface of the lithium nickel cobalt aluminum oxide lithium. The amount of the tungsten compound added was 0.35 mol % in terms of tungsten element relative to the total molar amount of the metal elements except lithium in the lithium nickel cobalt aluminum oxide. By SEM observation, the positive electrode active material was shown to bear the tungsten compound attached to the surface of both of the primary particles and the secondary particles.

### [Fabrication of Positive Electrode]

A positive electrode mixture slurry was prepared by stirring 100 mass % positive electrode active material obtained above, 1.25 mass % acetylene black as a conductive auxiliary and 1.00 mass % polyvinylidene fluoride as a binder together with an appropriate amount of N-methylpyrrolidone (NMP) with use of a kneader. Next, the positive electrode mixture slurry was applied to both sides of an aluminum foil (15 μm thick) as a positive electrode current collector 5a. The coated foil was rolled and was thereafter dried. A positive electrode plate was thus obtained.

The dried positive electrode plate was cut to a size 58.2 mm in coated width and 643.3 mm in coated length. In this manner, a positive electrode 5 was fabricated which had positive electrode mixture layers 5b on both sides of the positive electrode current collector 5a as illustrated in FIG. 2. In the positive electrode 5, the thickness of the positive electrode mixture layers 5b was 64.6 μm per side and the active material density was 3.60 g/cm³. Portions 5c and 5d of the positive electrode current collector which were 6.0 mm in width were not coated with the positive electrode mixture slurry and were exposed on both sides of the positive electrode 5 at central regions in the longitudinal direction. An end of a positive electrode lead 9 that was made of aluminum and had a width of 3.5 mm and a thickness of 0.15 mm was welded to the exposed portion 5c of the positive electrode current collector.

### [Fabrication of Negative Electrode]

A mixture of 96 mass % graphite and 4 mass % SiOₓ (x=1.0) was used as a negative electrode active material. A negative electrode mixture slurry was prepared by stirring the negative electrode active material and 1.0 mass % styrene butadiene rubber as a binder together with an appropriate amount of CMC with use of a kneader. Next, the negative electrode mixture slurry was applied to both sides of a long copper foil (8 μm thick) as a negative electrode current collector 6a. The coated foil was rolled with a pair of rolls and was thereafter dried. A negative electrode plate was thus obtained.

The dried negative electrode plate was cut to a size 59.2 mm in coated width and 711.8 mm in coated length. In this manner, a negative electrode 6 was fabricated which had negative electrode mixture layers 6b on both sides of the negative electrode current collector 6a as illustrated in FIG. 3. In the negative electrode 6, the thickness of the negative electrode mixture layers 6b was 77.3 μm per side and the active material density was 1.65 g/cm³. At one end of the negative electrode 6 in the longitudinal direction, portions 6c and 6d of the negative electrode current collector were exposed over a width of 2.0 mm on both sides. At the other end of the negative electrode 6 in the longitudinal direction, a portion 6e of the negative electrode current collector having a width of 23.0 mm was exposed on one side, and a portion 6f of the negative electrode current collector having a width of 76.0 mm was exposed on the other side. An end of a negative electrode lead (a clad lead) 10 that was Ni/Cu/Ni=25/50/25 having a width of 3.0 mm and a thickness of 0.10 mm was welded to the exposed portion 6f of the negative electrode current collector.

### [Fabrication of Electrode Assembly]

A microporous polyethylene membrane separator 7 which had a heat resistant layer including an aramid resin as a heat resistant material on one side was interposed between the positive electrode 5 and the negative electrode 6 obtained above so that the heat resistant layer faced the positive electrode 5. The separator 7 had a size 61.6 mm in width, 716.3 mm in length and 16.5 μm in thickness. Next, the positive electrode 5 and the negative electrode 6 were wound into a coil while applying a tension thereto so that a surface pressure of not less than 0.1 MPa/cm² would be present on the plane in which the positive electrode 5 and the negative electrode 6 were opposed to each other via the separator 7. An electrode assembly 4 was thus fabricated. The surface pressure was actually measured, and the plane in which the positive electrode 5 and the negative electrode 6 were opposed to each other via the separator 7 was found to be under a surface pressure of not less than 0.1 MPa.

### [Preparation of Nonaqueous Electrolyte]

Lithium hexafluorophosphate (LiPF₆) was dissolved into a 20:5:75 by volume solvent mixture of ethylene carbonate, ethyl methyl carbonate and dimethyl carbonate so that the concentration thereof would be 1.40 mol/L. Further, vinylene carbonate and lithium difluorophosphate were dissolved with concentrations of 4 mass % and 1 mass %, respectively, relative to the solvent mixture. A nonaqueous electrolyte was thus prepared.

### [Fabrication of Battery]

The electrode assembly 4 obtained was placed into a bottomed cylindrical metallic battery case 1 having an inner diameter of 17.94 mm, a height of 64.97 mm and a side thickness of 0.12 mm. The free end of the positive electrode lead 9 leading out from the electrode assembly 4 was welded to a sealing plate 2, and the free end of the negative electrode lead 10 was welded to the inner bottom surface of the battery case 1. Next, an inwardly protrudent step 11 was formed on the sidewall of the battery case 1 above the top surface of the electrode assembly 4, and thereby the electrode assembly 4 was held within the battery case 1. Next, the nonaqueous electrolyte described above was poured into the battery case 1, and the open end of the battery case 1 was crimped together with a peripheral portion of the sealing plate 2 via a gasket 3 to form a seal. A cylindrical nonaqueous electrolyte secondary battery was thus fabricated.

### Example 2

A nonaqueous electrolyte secondary battery was fabricated in the same manner as in EXAMPLE 1, except that the fabrication of the positive electrode 5 involved the tungsten compound in an amount of 0.30 mol % in terms of tungsten element relative to the total molar amount of the metal elements except lithium in the lithium nickel cobalt aluminum oxide, and that the negative electrode active material used in the fabrication of the negative electrode 6 was changed to a mixture of 93 mass % graphite and 7 mass % SiOₓ. In the positive electrode 5, the coated length was 600.0 mm, the thickness of the positive electrode mixture layers 5b after drying was 73.0 μm per side, and the active material density was 3.61 g/cm³. In the negative electrode 6, the coated length was 668.5 mm, the thickness of the negative electrode mixture layers 6b after drying was 80.5 μm per side, and the active material density was 1.60 g/cm³. The length of the separator 7 was 673.0 mm.

### Example 3

A nonaqueous electrolyte secondary battery was fabricated in the same manner as in EXAMPLE 1, except that lithium nickel cobalt aluminum oxide represented by LiNi_{0.88}Co_{0.09}Al_{0.03}O₂ was used as the base material in the fabrication of the positive electrode 5 in place of the lithium nickel cobalt aluminum oxide represented by LiNi_{0.91}Co_{0.06}Al_{0.03}O₂, and that the content of the conductive auxiliary and that of the binder in the positive electrode mixture layers were changed to 1.00 mass % and 0.90 mass %, respectively, relative to the positive electrode active material taken as 100 mass %. In the positive electrode 5, the coated length was 634.5 mm, the thickness of the positive electrode mixture layers 5b after drying was 66.9 μm per side, and the active material density was 3.63 g/cm³. In the negative electrode 6, the coated length was 701.0 mm, and the thickness of the negative electrode mixture layers 6b after drying was 76.5 μm per side. The length of the separator 7 was 707.5 mm.

### Example 4

A nonaqueous electrolyte secondary battery was fabricated in the same manner as in EXAMPLE 3, except that in the fabrication of the positive electrode 5, the content of the conductive auxiliary and that of the binder in the positive electrode mixture layers were changed to 1.25 mass % and 1.00 mass %, respectively, relative to the positive electrode active material taken as 100 mass %. In the positive electrode 5, the thickness of the positive electrode mixture layers 5b after drying was 67.5 μm per side, and the active material density was 3.60 g/cm³.

### Example 5

A nonaqueous electrolyte secondary battery was fabricated in the same manner as in EXAMPLE 3, except that in the fabrication of the positive electrode 5, the content of the conductive auxiliary and that of the binder in the positive electrode mixture layers were changed to 0.75 mass % and 0.675 mass %, respectively, relative to the positive electrode active material taken as 100 mass %. In the positive electrode 5, the thickness of the positive electrode mixture layers 5b after drying was 66.4 μm per side, and the active material density was 3.66 g/cm³.

### Comparative Example 1

A battery was fabricated in the same manner as in EXAMPLE 1, except that in the fabrication of the positive electrode 5, the content of the conductive auxiliary and that of the binder in the positive electrode mixture layers were changed to 0.75 mass % and 0.675 mass %, respectively, relative to the positive electrode active material taken as 100 mass %, and that the fabrication of the negative electrode 6 involved graphite alone as the negative electrode active material. In the positive electrode 5, the coated length was 562.0 mm, the thickness of the positive electrode mixture layers 5b after drying was 70.0 μm per side, and the active material density was 3.66 g/cm³. In the negative electrode 6, the coated length was 628.5 mm, the thickness of the negative electrode mixture layers 6b after drying was 95.0 μm per side, and the active material density was 1.66 g/cm³. The length of the separator 7 was 635.0 mm.

### Comparative Example 2

A battery was fabricated in the same manner as in EXAMPLE 3, except that in the fabrication of the positive electrode 5, the content of the conductive auxiliary and that of the binder in the positive electrode mixture layers were changed to 0.75 mass % and 0.675 mass %, respectively, relative to the positive electrode active material taken as 100 mass %, and that the fabrication of the negative electrode 6 involved graphite alone as the negative electrode active material. In the positive electrode 5, the coated length was 562.0 mm, the thickness of the positive electrode mixture layers 5b after drying was 71.5 in per side, and the active material density was 3.66 g/cm³. In the negative electrode 6, the coated length was 628.5 mm, the thickness of the negative electrode mixture layers 6b after drying was 95.0 in per side, and the active material density was 1.66 g/cm³. The length of the separator 7 was 635.0 mm.

### Comparative Example 3

A nonaqueous electrolyte secondary battery was fabricated in the same manner as in EXAMPLE 3, except that lithium nickel cobalt aluminum oxide represented by LiNi_{0.82}Co_{0.15}Al_{0.03}O₂ was used as the base material in the fabrication of the positive electrode 5 in place of the lithium nickel cobalt aluminum oxide represented by LiNi_{0.88}Co_{0.09}Al_{0.03}O₂, that the amount of the tungsten compound was changed to 0.36 mol % in terms of tungsten element relative to the total molar amount of the metal elements except lithium in the lithium nickel cobalt aluminum oxide, and that the fabrication of the negative electrode 6 involved graphite alone as the negative electrode active material. In the positive electrode 5, the coated length was 660.5 mm, and the thickness of the positive electrode mixture layers 5b after drying was 60.5 μm per side. In the negative electrode 6, the coated length was 727.0 mm, the thickness of the negative electrode mixture layers 6b after drying was 75.5 μm per side, and the active material density was 1.66 g/cm³. The length of the separator 7 was 733.5 mm.

### Comparative Example 4

A nonaqueous electrolyte secondary battery was fabricated in the same manner as in COMPARATIVE EXAMPLE 3, except that the negative electrode active material used in the fabrication of the negative electrode 6 was changed to a mixture of 96 mass % graphite and 4 mass % SiOₓ. In the positive electrode 5, the thickness of the positive electrode mixture layers 5b after drying was 65.5 μm per side. In the negative electrode 6, the thickness of the negative electrode mixture layers 6b after drying was 74.0 μm per side, and the active material density was 1.65 g/cm³.

### (Experiments)

### [Measurement of High-Temperature Cycle Characteristics]

At a temperature of 45° C., the batteries of EXAMPLES 1 to 5 and COMPARATIVE EXAMPLES 1 to 4 were each charged at a constant current of 0.3-hour rate until the battery voltage reached 4.2 V and were charged at a constant voltage of 4.2 V until a final current of 0.02-hour rate was reached. After a rest of 20 minutes, the batteries were discharged at a constant discharge current of 0.5-hour rate until the battery voltage reached 2.5 V, and were allowed to rest for 20 minutes. This charge discharge cycle was repeated 100 times. The ratio of the discharge capacity in the 100th cycle to the discharge capacity in the 1st cycle (the capacity retention ratio) was determined. Table 1 describes the values of capacity retention ratio after 100 cycles at 45° C. in EXAMPLES 1 to 5 and COMPARATIVE EXAMPLES 1 to 4.

### [Measurement of 0.2 C (Hour Rate) Discharge Capacities]

At a temperature of 25° C., the batteries of EXAMPLES 1 to 5 and COMPARATIVE EXAMPLES 1 to 4 were each charged at a constant current of 0.5-hour rate until the battery voltage reached 4.2 V and were charged at a constant voltage of 4.2 V until a final current of 0.02-hour rate was reached. After a rest of 20 minutes, the batteries were discharged at a constant discharge current of 0.2-hour rate until the battery voltage reached 2.5 V. The 0.2 C (hour rate) discharge capacity, and the discharge capacity per unit area in which the positive and negative electrodes were opposed to each other of the batteries were determined. Table 1 describes the 0.2 C discharge capacities of EXAMPLES 1 to 5 and COMPARATIVE EXAMPLES 1 to 4. The discharge capacity per unit area is the discharge capacity of single-sided electrodes.

TABLE 1

| | Composition ratio | | | Content of | | | Capacity | 0.2 C | Capacity |
|---|---|---|---|---|---|---|---|---|---|
| | of positive electrode | | | conductive | W | SiOₓ | retention ratio | discharge | per unit |
| | active material | | | auxiliary | content | content | [%] | capacity | area |
| | Ni | Co | Al | [mass %] | [mol %] | [mass %] | @100∞, 45° C. | [mAh/g] | [mAh/cm²] |
| COMP. EX. 1 | 91 | 6 | 3 | 0.75 | 0.35 | 0 | 86.0 | 205.6 | 5.2 |
| EX. 1 | 91 | 6 | 3 | 1.25 | 0.35 | 4 | 87.7 | 199.1 | 4.6 |
| EX. 2 | 91 | 6 | 3 | 1.25 | 0.30 | 7 | 90.6 | 193.5 | 5.0 |
| COMP. EX. 2 | 88 | 9 | 3 | 0.75 | 0.35 | 0 | 82.6 | 197.7 | 5.1 |
| EX. 3 | 88 | 9 | 3 | 1.00 | 0.35 | 4 | 90.9 | 194.0 | 4.6 |
| EX. 4 | 88 | 9 | 3 | 1.25 | 0.35 | 4 | 91.7 | 193.8 | 4.6 |
| EX. 5 | 88 | 9 | 3 | 0.75 | 0.35 | 4 | 88.2 | 193.6 | 4.6 |
| COMP. EX. 3 | 82 | 15 | 3 | 1.00 | 0.36 | 0 | 93.6 | 192.1 | 4.1 |
| COMP. EX. 4 | 82 | 15 | 3 | 1.00 | 0.36 | 4 | 92.1 | 183.6 | 4.3 |

As clear from Table 1, EXAMPLES 3 to 5, in which the Ni proportion was 88 mol % and the SiOₓ content in the negative electrode 6 was 4 mass %, resulted in excellent high-temperature cycle characteristics and attained an enhancement in capacity retention ratio as compared with COMPARATIVE EXAMPLE 2 in which SiOₓ was absent in the negative electrode 6, irrespective of the content of the conductive auxiliary. Further, EXAMPLE 1, in which the Ni proportion was 91 mol % and the SiOₓ content in the negative electrode 6 was 4 mass %, and EXAMPLE 2, in which the SiOₓ content in the negative electrode 6 was 7 mass %, resulted in enhanced high-temperature cycle characteristics over COMPARATIVE EXAMPLE 1 in which SiOₓ was absent in the negative electrode 6. The high-temperature cycle characteristics were better in EXAMPLE 2 in which the SiOₓ content in the negative electrode 6 was 7 mass % than in EXAMPLE 1 in which the SiOₓ content in the negative electrode 6 was 4 mass %. This result shows that the expansion of the positive electrode 5 associated with charging and discharging is suppressed more effectively with increasing amount of SiOₓ in the negative electrode 6.

No enhancements in high-temperature cycle characteristics were recognized between COMPARATIVE EXAMPLE 3 and COMPARATIVE EXAMPLE 4 in which the Ni proportion was 82%, irrespective of the content of SiOₓ in the negative electrode 6. The reasons why these results were obtained are probably as follows. In COMPARATIVE EXAMPLE 3 and COMPARATIVE EXAMPLE 4, the Ni proportion was 82 mol % and was lower than that in EXAMPLES 1 and 2 (91 mol % Ni) and that in EXAMPLES 3 to 5 (88 mol % Ni), and the electrode plate resistance of the positive electrode 5 was lower because of the low Ni proportion. It is therefore probable that the electrode plate resistance of the positive electrode 5 was not much increased during the high-temperature charge discharge cycles which would have caused the electrode to expand, and consequently no enhancements in high-temperature cycle characteristics were seen.

### Second Experimental Examples

### Example 6

A nonaqueous electrolyte secondary battery was fabricated in the same manner as in EXAMPLE 2, except that the fabrication of the positive electrode 5 involved the tungsten compound in an amount of 0.15 mol % in terms of tungsten element relative to the total molar amount of the metal elements except lithium in the lithium nickel cobalt aluminum oxide, and that the lithium difluorophosphate was not used in the nonaqueous electrolyte. In the positive electrode 5, the coated length was 635.5 mm, the thickness of the positive electrode mixture layers 5b after drying was 68.0 μm per side, and the active material density was 3.59 g/cm³. In the negative electrode 6, the coated length was 704.0 mm, and the thickness of the negative electrode mixture layers 6b after drying was 74.5 μm³ per side. The length of the separator 7 was 708.5 mm.

### Example 7

A nonaqueous electrolyte secondary battery was fabricated in the same manner as in EXAMPLE 6, except that 0.5 mass % lithium difluorophosphate was used in the nonaqueous electrolyte.

### Example 8

A nonaqueous electrolyte secondary battery was fabricated in the same manner as in EXAMPLE 6, except that 1.0 mass % lithium difluorophosphate was used in the nonaqueous electrolyte.

### (Experiment)

### [Measurement of 0.2 C (Hour Rate) Discharge Capacities]

At a temperature of 25° C., the batteries of EXAMPLES 6 to 8 were each charged at a constant current of 0.5-hour rate until the battery voltage reached 4.2 V and were charged at a constant voltage of 4.2 V until a final current of 0.02-hour rate was reached. After a rest of 20 minutes, the batteries were discharged at a constant discharge current of 0.2-hour rate until the battery voltage reached 2.5 V, and were allowed to rest for 20 minutes. Table 2 describes the 0.2 C discharge capacities of EXAMPLES 6 to 8.

TABLE 2

| | Composition ratio | | | Amount of | | | | 0.2 C |
|---|---|---|---|---|---|---|---|---|
| | of positive electrode | | | conductive | W | SiOₓ | Amount of | discharge |
| | active material | | | auxiliary | content | content | additive | capacity |
| | Ni | Co | Al | [mass %] | [mol %] | [mass %] | [mass %] | [mAh/g] |
| EX. 6 | 91 | 6 | 3 | 1.25 | 0.15 | 7 | 0 | 197.6 |
| EX. 7 | 91 | 6 | 3 | 1.25 | 0.15 | 7 | 0.5 | 198.5 |
| EX. 8 | 91 | 6 | 3 | 1.25 | 0.15 | 7 | 1.0 | 198.7 |

As clear from Table 2, the addition of lithium difluorophosphate to the nonaqueous electrolyte is effective for enhancing the 0.2 C discharge capacity as compared to when the lithium difluorophosphate is absent in the nonaqueous electrolyte. The reason for this result, although not exactly known, is probably as described below.

When present in the nonaqueous electrolyte, lithium difluorophosphate is decomposed on the tungsten compound to form a film on the surface of the positive electrode active material. The film thus formed can prevent the tungsten compound from being dissolved during charging and discharging. It is therefore probable that the reaction resistance of the positive electrode 5 was effectively kept at a low level and consequently the discharge capacity was enhanced.

### Third Experimental Examples

### Example 9

A nonaqueous electrolyte secondary battery was fabricated in the same manner as in EXAMPLE 8, except that the concentration of the lithium salt in the nonaqueous electrolyte was changed to 1.3 M.

### Example 10

A nonaqueous electrolyte secondary battery was fabricated in the same manner as in EXAMPLE 8, except that the concentration of the lithium salt in the nonaqueous electrolyte was changed to 1.2 M.

### Example 11

A nonaqueous electrolyte secondary battery was fabricated in the same manner as in EXAMPLE 8, except that the tungsten compound was not added in the fabrication of the positive electrode 5.

### Example 12

A nonaqueous electrolyte secondary battery was fabricated in the same manner as in EXAMPLE 11, except that the concentration of the lithium salt in the nonaqueous electrolyte was changed to 1.3 M.

### Example 13

A nonaqueous electrolyte secondary battery was fabricated in the same manner as in EXAMPLE 11, except that the concentration of the lithium salt in the nonaqueous electrolyte was changed to 1.2 M.

The 0.2 C discharge capacities of the batteries of EXAMPLES 9 to 13 were determined in the same manner as for the batteries of EXAMPLES 6 to 8. Table 3 describes the 0.2 C discharge capacities of the batteries of EXAMPLES 9 to 13.

TABLE 3

| | Composition ratio | | | Amount of | | | | 0.2 C |
|---|---|---|---|---|---|---|---|---|
| | of positive electrode | | | conductive | W | SiOₓ | Concentration | discharge |
| | active material | | | auxiliary | content | content | of lithium salt | capacity |
| | Ni | Co | Al | [mass %] | [mol %] | [mass %] | [M] | [mAh/g] |
| EX. 8 | 91 | 6 | 3 | 1.25 | 0.15 | 7 | 1.4 | 198.7 |
| EX. 9 | 91 | 6 | 3 | 1.25 | 0.15 | 7 | 1.3 | 196.7 |
| EX. 10 | 91 | 6 | 3 | 1.25 | 0.15 | 7 | 1.2 | 196.4 |
| EX. 11 | 91 | 6 | 3 | 1.25 | 0 | 7 | 1.4 | 198.6 |
| EX. 12 | 91 | 6 | 3 | 1.25 | 0 | 7 | 1.3 | 198.4 |
| EX. 13 | 91 | 6 | 3 | 1.25 | 0 | 7 | 1.2 | 197.0 |

As clear from Table 3, the 0.2 C discharge capacity reached the maximum when the concentration of the lithium salt in the nonaqueous electrolyte was highest, namely, 1.4 M. The enhancement in discharge capacity is probably ascribed to the increase in lithium diffusion rate with increasing concentration of the lithium salt.

### Reference Experiment 1

### Reference Example 1

A nonaqueous electrolyte secondary battery was fabricated in the same manner as in COMPARATIVE EXAMPLE 3, except that the tungsten compound was not added in the fabrication of the positive electrode 5, and that the electrode assembly 4 was fabricated while interposing carbonless copy paper between the positive electrode 5 and the negative electrode 6 via the separator 7.

### (Experiment)

### [Measurement of Surface Pressure]

The battery of REFERENCE EXAMPLE 1 in a 4.2 V charged state (100% SOC) was tested to measure the surface pressure present on the facing surfaces of the positive electrode 5 and the negative electrode 6 which were opposed to each other through the separator. The surface pressure was measured with respect to 4 positions at distances of 50 mm, 250 mm, 450 mm and 600 mm from the innermost core of the electrode assembly 4. The results are described in Table 4.

TABLE 4

Distance (mm) from core

| | 50 | 250 | 450 | 600 |
|---|---|---|---|---|
| Surface pressure | 0.25 | 0.62 | 0.33 | 0.30 |
| (MPa/cm²) | | | | |

From Table 4, the surface pressure present on a plane in which the positive electrode 5 and the negative electrode 6 are opposed to each other through the separator 7 varies depending on the distance from the core in the electrode assembly 4. The presence of such variations will facilitate the diffusion of the electrolytic solution during charging and discharging.

### Reference Experiment 2

### Reference Example 2

A nonaqueous electrolyte secondary battery was fabricated in the same manner as in EXAMPLE 5, except that the tungsten compound was not added in the fabrication of the positive electrode 5, that the fabrication of the negative electrode 6 involved graphite alone as the negative electrode active material, and that the positive electrode 5 and the negative electrode 6 were stacked via the separator and the resultant electrode assembly 4 was inserted into a laminate package made of aluminum in a glove box in an argon atmosphere.

### Reference Example 3

A nonaqueous electrolyte secondary battery was fabricated in the same manner as in REFERENCE EXAMPLE 2, except that the negative electrode active material used in the fabrication of the negative electrode 6 was replaced by a mixture of 93 mass % graphite and 7 mass % SiOₓ (x=1.0). The thickness of the negative electrode mixture layers was controlled in accordance with the amount of SiOₓ present in the negative electrode 6.

### Reference Example 4

A nonaqueous electrolyte secondary battery was fabricated in the same manner as in REFERENCE EXAMPLE 2, except that the negative electrode active material used in the fabrication of the negative electrode 6 was replaced by a mixture of 80 mass % graphite and 20 mass % SiOₓ (x=1.0). The thickness of the negative electrode mixture layers was controlled in accordance with the amount of SiOₓ present in the negative electrode 6.

### (Experiment)

### [Measurement of Expansion Ratio of Negative Electrode]

With respect to the batteries of REFERENCE EXAMPLES 2 to 4, the ratio of expansion of the negative electrode 6 in a 4.2 V charged state (100% SOC) was measured relative to the volume before charging (0% SOC). The results are described in Table 5.

TABLE 5

| | Composition ratio | | | Amount of | | | Ratio of |
|---|---|---|---|---|---|---|---|
| | of positive electrode | | | conductive | W | SiOₓ | expansion |
| | active material | | | auxiliary | content | content | after charging |
| | Ni | Co | Al | [mass %] | [mol %] | [mass %] | [%] |
| REF. EX. 2 | 88 | 9 | 3 | 0.75 | 0 | 0 | 114 |
| REF. EX. 3 | 88 | 9 | 3 | 0.75 | 0 | 7 | 117 |
| REF. EX. 4 | 88 | 9 | 3 | 0.75 | 0 | 20 | 148 |

As clear from Table 5, the expansion ratio of the negative electrode was increased with increasing amount of SiOₓ in the negative electrode 6. In view of the fact that the negative electrodes 6 in EXAMPLES 3 to 5 are similar to the negative electrodes 6 in REFERENCE EXAMPLES 2 to 4 in that they all contained SiOₓ, it is probable that the negative electrodes 6 in these EXAMPLES applied a higher pressure to the positive electrode 5 than in REFERENCE EXAMPLE 1 shown in Table 4 and the increase in contact resistance of the positive electrode 5 was suppressed as a result.

### Reference Experiment 3

### Reference Example 5

A nonaqueous electrolyte secondary battery was fabricated in the same manner as in EXAMPLE 2, except that the tungsten compound was not added in the fabrication of the positive electrode 5. In the positive electrode 5, the coated width was 57.6 mm, the coated length was 633.0 mm, the thickness of the positive electrode mixture layers 5b after drying was 68.5 μm per side, and the active material density was 3.57 g/cm³. In the negative electrode 6, the coated width was 58.6 mm, the coated length was 701.5 mm, the thickness of the negative electrode mixture layers 6b after drying was 75.5 nm per side, and the active material density was 1.59 g/cm³. The length of the separator 7 was 706.0 mm.

### Reference Example 6

A nonaqueous electrolyte secondary battery was fabricated in the same manner as in REFERENCE EXAMPLE 5, except that the fabrication of the negative electrode 6 involved the tungsten compound in an amount of 0.10 mol % in terms of W element relative to the total molar amount of the metal elements except lithium in the lithium nickel cobalt aluminum oxide.

### Reference Example 7

A nonaqueous electrolyte secondary battery was fabricated in the same manner as in REFERENCE EXAMPLE 5, except that the fabrication of the negative electrode 6 involved the tungsten compound in an amount of 0.15 mol % in terms of W element relative to the total molar amount of the metal elements except lithium in the lithium nickel cobalt aluminum oxide.

### Reference Example 8

A nonaqueous electrolyte secondary battery was fabricated in the same manner as in REFERENCE EXAMPLE 5, except that the fabrication of the negative electrode 6 involved the tungsten compound in an amount of 1 mol % in terms of W element relative to the total molar amount of the metal elements except lithium in the lithium nickel cobalt aluminum oxide.

### (Experiments)

### [Measurement of High-Temperature Cycle Characteristics]

At a temperature of 45° C., the batteries of EXAMPLE 2 and REFERENCE EXAMPLES 5 to 8 were each charged at a constant current of 0.3-hour rate until the battery voltage reached 4.2 V and were charged at a constant voltage of 4.2 V until a final current of 0.02-hour rate was reached. After a rest of 20 minutes, the batteries were discharged at a constant discharge current of 0.5-hour rate until the battery voltage reached 2.5 V, and were allowed to rest for 20 minutes. This charge discharge cycle was repeated 100 times. The ratio of the discharge capacity in the 100th cycle to the discharge capacity in the 1st cycle (the capacity retention ratio) was determined. Table 6 describes the values of capacity retention ratio after 100 cycles at 45° C. in EXAMPLE 2 and REFERENCE EXAMPLES 5 to 8.

### [Measurement of 0.2 C (Hour Rate) Discharge Capacities]

At a temperature of 25° C., the batteries of EXAMPLE 2 and REFERENCE EXAMPLES 5 to 8 were each charged at a constant current of 0.5-hour rate until the battery voltage reached 4.2 V and were charged at a constant voltage of 4.2 V until a final current of 0.02-hour rate was reached. After a rest of 20 minutes, the batteries were discharged at a constant discharge current of 0.2-hour rate until the battery voltage reached 2.5 V. The 0.2 C (hour rate) discharge capacity, and the discharge capacity per unit area in which the positive and negative electrodes were opposed to each other were determined. Table 6 describes the 0.2 C discharge capacities of EXAMPLE 2 and REFERENCE EXAMPLES 5 to 8. The discharge capacity per unit area is the discharge capacity of single-sided electrodes.

TABLE 6

| | Composition ratio | | | Content of | | | Capacity | 0.2 C | Capacity |
|---|---|---|---|---|---|---|---|---|---|
| | of positive electrode | | | conductive | W | SiOₓ | retention ratio | discharge | per unit |
| | active material | | | auxiliary | content | content | [%] | capacity | area |
| | Ni | Co | Al | [mass %] | [mol %] | [mass %] | @100∞, 45° C. | [mAh/g] | [mAh/cm²] |
| REF. EX. 5 | 91 | 6 | 3 | 1.25 | 0 | 7 | 88.8 | 191.8 | 4.6 |
| REF. EX. 6 | 91 | 6 | 3 | 1.25 | 0.10 | 7 | 89.1 | 195.7 | 4.7 |
| REF. EX. 7 | 91 | 6 | 3 | 1.25 | 0.15 | 7 | 90.2 | 196.8 | 4.7 |
| EX. 2 | 91 | 6 | 3 | 1.25 | 0.30 | 7 | 90.6 | 193.5 | 5.0 |
| REF. EX. 8 | 91 | 6 | 3 | 1.25 | 1.00 | 7 | 90.7 | 191.9 | 4.6 |

As clear from Table 6, EXAMPLE 2 and REFERENCE EXAMPLES 6 to 8 resulted in an enhancement in capacity retention ratio as compared to REFERENCE EXAMPLE 5. That is, the battery of REFERENCE EXAMPLE 5, which had a SiOₓ content of 7 mass % but involved no tungsten compound, failed to attain an enhanced capacity retention ratio. REFERENCE EXAMPLE 8 in which the amount of the tungsten compound was 1 mass % resulted in a similar enhancement in capacity retention ratio as EXAMPLE 2. This result will show that the high-temperature cycle characteristics are enhanced as long as a tungsten compound is present in the positive electrode 5.

### Reference Experiment 4

### Reference Example 9

A positive electrode active material of REFERENCE EXAMPLE 9 was prepared using the same composition ratio of the positive electrode active material and the same content of the tungsten compound as in EXAMPLE 1.

### Reference Example 10

A positive electrode active material of REFERENCE EXAMPLE 10 was prepared using the same composition ratio of the positive electrode active material and the same content of the tungsten compound as in EXAMPLE 11.

### Reference Example 11

A positive electrode active material of REFERENCE EXAMPLE 11 was prepared using the same composition ratio of the positive electrode active material and the same content of the tungsten compound as in EXAMPLE 3.

### Reference Example 12

A positive electrode active material was prepared in the same manner as in REFERENCE EXAMPLE 11, except that the tungsten compound was not added.

### Reference Example 13

A positive electrode active material was prepared in the same manner as in REFERENCE EXAMPLE 9, except that the lithium nickel cobalt aluminum oxide represented by LiNi_{0.91}Co_{0.06}Al_{0.03}O₂ was replaced by lithium nickel cobalt aluminum oxide represented by LiNi_{0.82}Co_{0.15}Al_{0.03}O₂.

### Reference Example 14

A positive electrode active material was prepared in the same manner as in REFERENCE EXAMPLE 13, except that the tungsten compound was not added.

### (Experiment)

### [Measurement of Volume Resistivity]

The positive electrode active materials of REFERENCE EXAMPLES 9 to 14 were each tested to determine the volume resistivity of the positive electrode active material in the form of powder under a load of 20 kN. The volume resistivity of a powder is also called the powder resistivity. The measurement results are described in Table 7.

TABLE 7

| | Composition ratio | | | | |
|---|---|---|---|---|---|
| | of positive electrode | | | | |
| | active material | | | W content | Volume resistivity |
| | Ni | Co | Al | [mol %] | [Ω · cm] |
| REF. EX. 9 | 91 | 6 | 3 | 0.35 | 12.3 |
| REF. EX. 10 | 91 | 6 | 3 | 0 | 7.5 |
| REF. EX. 11 | 88 | 9 | 3 | 0.35 | 12.1 |
| REF. EX. 12 | 88 | 9 | 3 | 0 | 7.4 |
| REF. EX. 13 | 82 | 15 | 3 | 0.35 | 11.3 |
| REF. EX. 14 | 82 | 15 | 3 | 0 | 6.1 |

As clear from Table 7, the volume resistivity of the positive electrode active material was increased with increasing proportion of Ni. Further, the addition of the tungsten compound resulted in an increase in volume resistivity as compared to when no tungsten compound was added. As demonstrated above, the volume resistivity of a powdery positive electrode active material, or the powder resistivity, is increased with increasing proportion of Ni. In other words, the electronic resistance of a positive electrode active material is increased with increasing proportion of Ni.

### INDUSTRIAL APPLICABILITY

One aspect of the present disclosure is expected to be applied to, for example, power supplies for driving of mobile information terminals such as cellphones, laptop computers and smartphones, power supplies with high capacity and excellent low-temperature characteristics for driving of BEV, PHEV and HEV, and storage-related power supplies.

### REFERENCE SIGNS LIST

1 BATTERY CASE
2 SEALING PLATE
3 GASKET
4 ELECTRODE ASSEMBLY
5 POSITIVE ELECTRODE
5a POSITIVE ELECTRODE CURRENT COLLECTOR
5b POSITIVE ELECTRODE MIXTURE LAYER
5c, 5d EXPOSED PORTIONS OF POSITIVE ELECTRODE CURRENT COLLECTOR
6 NEGATIVE ELECTRODE
6a NEGATIVE ELECTRODE CURRENT COLLECTOR
6b NEGATIVE ELECTRODE MIXTURE LAYER
6c, 6d, 6e, 6f EXPOSED PORTIONS OF NEGATIVE ELECTRODE CURRENT COLLECTOR
7 SEPARATOR
8a UPPER INSULATING RING
8b LOWER INSULATING RING
9 POSITIVE ELECTRODE LEAD
10 NEGATIVE ELECTRODE LEAD
11 STEP

1. A nonaqueous electrolyte secondary battery comprising an electrode assembly that comprises a positive electrode including a positive electrode current collector and a positive electrode mixture layer disposed on the positive electrode current collector, a negative electrode including a negative electrode current collector and a negative electrode mixture layer disposed on the negative electrode current collector, and a separator, wherein
the positive electrode mixture layer comprises a lithium transition metal oxide containing Ni in a proportion of not less than 85 mol % relative to the total molar amount of metal element(s) except lithium, and bearing on the surface thereof an attached element belonging to Group VI of the periodic table,
the negative electrode mixture layer comprises a carbon material and a silicon compound, and
the surface pressure present on a plane in which the positive electrode and the negative electrode are opposed to each other through the separator is not less than 0.1 MPa/cm².

2. The nonaqueous electrolyte secondary battery according to claim 1, wherein the lithium transition metal oxide is represented by the general formula: LiₐNiₓM₁₋ₓO₂ (wherein 0.95≤a≤1.2, 0.85≤x≤1.0, and M includes at least Co and Al).

3. The nonaqueous electrolyte secondary battery according to claim 1, wherein the content of the silicon compound is not less than 5 mass % and less than 30 mass % of the total mass of the carbon material and the silicon compound present in the negative electrode mixture layer.

4. The nonaqueous electrolyte secondary battery according to claim 1, wherein the surface pressure present on a plane in which the positive electrode and the negative electrode are opposed to each other at an outermost periphery of the electrode assembly is not less than 0.1 MPa/cm² at 100% SOC.

5. The nonaqueous electrolyte secondary battery according to claim 1, wherein the positive electrode mixture layer has a volume resistivity under a load of 20 kN of higher than 6.1 Ωcm.
